(19) United States
(12) Patent Application Publication
(10) Pub. No.: US 2004/0044643 A1
(43) Pub. Date: Mar. 4, 2004

(54) Managing multiple virtual machines

(76) Inventors: David A. deVries, Ottawa (CA); Arthur G. Olbert, Austin, TX (US); David M. O'Neill, Ottawa (CA); Christopher Neufeld, Ottawa (CA)

Correspondence Address: FENWICK & WEST LLP, SILICON VALLEY CENTER, 801 CALIFORNIA STREET, MOUNTAIN VIEW, CA, 94041, US

(21) Appl. No.: 10/413,440

(22) Filed: Apr. 10, 2003

Related U.S. Application Data
(60) Provisional application No. 60/372,256, filed on Apr. 11, 2002.

(51) Int. Cl. G06F 7/00

(52) U.S. Cl. 707/1

(57) ABSTRACT

A mainframe computer executes multiple instances of virtual machines. An administrator uses a set of manager instances to create and manage a set of managed instances. The manager instances include a configuration manager that creates managed instances according to templates. A template describes aspects of a managed instance, including the resources and software available to it. The manager instances also include a file server that maps file access requests from managed instances to files in a storage device. The administrator installs software in the storage device and uses the templates and other data to create mappings in the file server that allow multiple managed instances to independently execute the software. The administrator can easily maintain the managed instances and software executed by the machines.

### CROSS-REFERENCE TO RELATED APPLICATION

This application claims the benefit of U.S. Provisional Application No. 60/372,256, filed Apr. 11, 2002, and incorporated herein by reference.

### BACKGROUND OF THE INVENTION

1. Field of the Invention

This invention pertains in general to mainframe computer systems and in particular to techniques for executing instances of virtual machines on the mainframe computer systems.

2. Background Art

A large enterprise, such as a company, frequently has at least two different computing departments: mainframe and distributed. The mainframe department typically has a small number of high-powered mainframe computer systems. The mainframe computers typically perform tasks such as financial transaction processing and other large jobs. The distributed department typically has a large number of relatively low-powered workstations or servers. These distributed computer systems often perform discrete tasks such as operating web servers or acting as development workstations. Due to the nature of these tasks, the distributed computer systems are often idle.

For cost containment and other reasons, enterprises often desire to combine the operations of the mainframe and distributed computing departments. The mainframe computer systems offer high-availability and powerful processing capabilities, along with centralized management. In many cases, therefore, the enterprises find it more efficient from a resource-utilization viewpoint to perform tasks on a mainframe computer instead of a distributed computer that might remain idle much of the time. Thus, there is a general desire to perform functions typically performed by distributed computers on a mainframe computer system.

Modern mainframe computer systems are designed to operate as multiple “virtual” computers. Through a combination of specialized software and hardware, a single, powerful mainframe computer can be logically divided into a large number of self-contained virtual computer systems. Each virtual computer system is functionally equivalent to a physical computer system, even though it is in reality sharing resources, such as storage, direct access storage devices (DASDs), and processing cycles with other virtual computer systems executing on the same mainframe.

Each virtual computer system executing on the mainframe can run a separate operating system. Accordingly, the virtual computer systems can run different operating systems and/or multiple instances of the same operating system. The operating systems, in turn, execute application programs. It is therefore possible to consolidate the functionality provided by multiple distributed computer systems into multiple instances of virtual machines executing on a mainframe computer system.

In practice, however, this consolidation is quite difficult. Often, the people in the enterprise that are most familiar with the distributed computer systems are not as familiar with the mainframe computer system and vice versa. As a result, it is difficult for the distributed computing people to set up, optimize, and maintain the virtual computer systems. Likewise, the mainframe computing people are not equipped to optimize the operation of distributed computing operating systems and applications.

In addition, it is often difficult to manage a large number of virtual computer systems executing the same, or different, versions of an operating system. For example, if 100 virtual computer systems are executing the Linux operating system, there is no convenient way to install a software update on all of the virtual computers. Similarly, it is difficult to ensure or determine whether the operating systems and/or applications are starting from a consistent state.

Accordingly, there is a need in the art for a way to conveniently create and maintain virtual computer systems in a mainframe computing environment and to install and maintain the operating systems and applications that execute within the virtual computer systems.

### DISCLOSURE OF INVENTION

The above needs are met by providing a set of manager virtual machine instances that a mainframe computer administrator utilizes to create and maintain a set of managed virtual machine instances. The manager instances include a configuration manager (CM) and a pair of file servers. The administrator uses the CM to control the manager instances and managed instances through a user interface, such as a web-based interface and/or a command-line interface.

The CM includes a database that holds data utilized to create and maintain the managed instances. The database includes a template module that holds one or more managed instance templates. A template specifies aspects of a managed instance, such as the computing resources and software available to the instance. The database also includes a packages module that describes the software packages and operating systems available to the managed instances. In one embodiment, the packages module describes the files in a direct access storage device (DASD) forming each operating system and/or software package. The database further includes an instance groups module that describes relationships, such as access rights, among groups of managed instances and users.

The file servers operate in a fault tolerant configuration and provide files to the managed instances. In one embodiment, the file servers make files stored in the DASD appear to the managed instances as if the files were on a network file system (NFS) shared volume. The file servers preferably include a file database that transparently maps file requests from the managed instances to possibly-different files in the DASD. This mapping functionality allows different managed instance to reference the same program code yet access different data.

In one embodiment, an administrator installs one or more operating systems and/or software packages in the DASD. The administrator also establishes one or more templates for the managed instances. The administrator uses the CM to create a managed instance based upon one of the templates. The CM establishes mappings in the file servers that allow the managed instance to access the appropriate files in the DASD for any operating system and/or software packages specified by the template.

The administrator can easily maintain the managed instances because the files are stored in a centralized location, the DASD, and the instances' access to the files is controlled by the file servers. The administrator can roll out and/or roll back configuration changes by changing the files in the DASD and/or changing the mappings implemented by the file servers. Moreover, the administrator can establish templates for managed instances optimized for specific purposes, such as web serving or application development, and use the CM to execute multiple instances of the optimized managed instances on the mainframe.

### BRIEF DESCRIPTION OF THE DRAWINGS

FIG. 1 is a high-level block diagram illustrating a simplified logical view of a mainframe computer system;

FIG. 2 is a high-level block diagram illustrating a more detailed view of a logical partition of the mainframe computer system and four manager instances executing on the partition;

FIG. 3 is a high-level block diagram illustrating an operational view of a system according to the present invention;

FIG. 4 is a high-level block diagram illustrating a more detailed view of the database in the configuration manager virtual machine; and

FIG. 5 is a flow chart illustrating steps for utilizing the system of FIG. 3 to manage multiple virtual machine instances according to one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

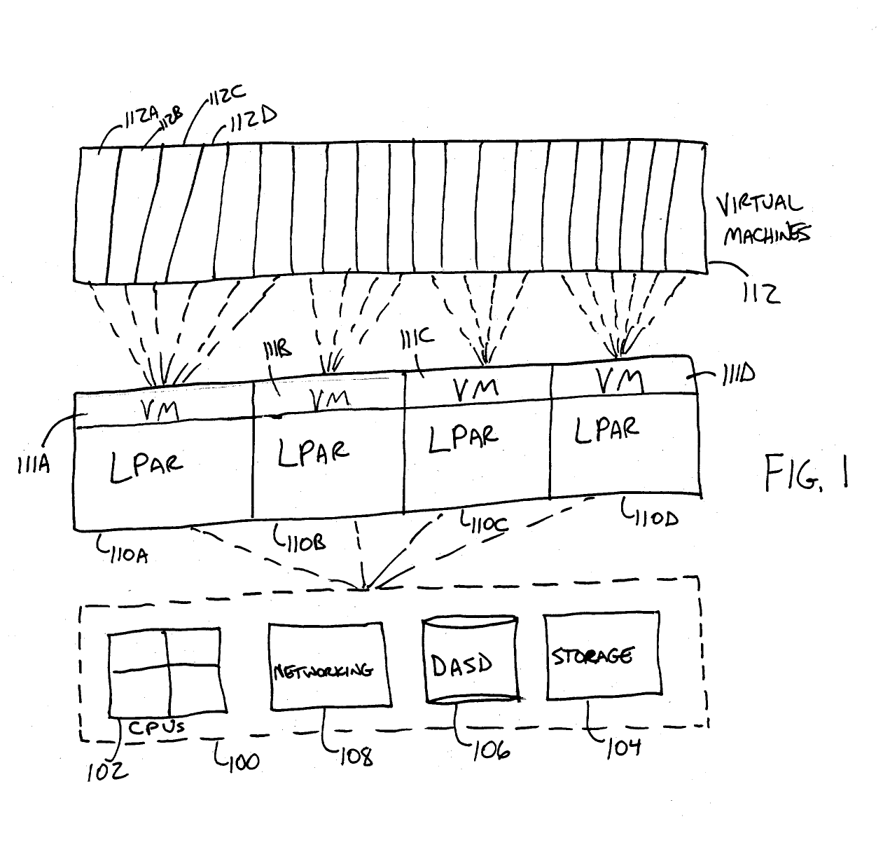

FIG. 1 is a high-level block diagram illustrating a simplified logical view of a mainframe computer system 100. In this description, the terms “mainframe,” “mainframe computer,” and “mainframe computer system” are used interchangeably to refer to the same entity. Similarly, this description also refers to the virtual computer systems 112 executed on the mainframe 100 as “virtual computers” and “virtual machines” and “instances.” Moreover, FIG. 1 and the other figures use like reference numerals to identify like elements. A letter after a reference numeral, such as “112A,” indicates that the text refers specifically to the element having that particular reference numeral. A reference numeral in the text without a following letter, such as “112,” refers to any or all of the elements in the figures bearing that reference number (e.g. “112” in the text refers to reference numerals “112A,” “112B,” “112C,” and/or “112D” in the figures).

The mainframe 100 of FIG. 1 includes central processing units (CPUs) 102, a storage 104, a direct access storage device (DASD) 106, and a networking facility 108. The CPUs 102 are preferably conventional mainframe-compatible CPUs. As is known in the art, the mainframe 100 typically has multiple CPUs 102 in order to provide high throughput and fault-tolerant operation. The CPUs 102 perform functions such as executing instructions contained in software, controlling input/output (I/O), etc. The storage 104 is random access memory (RAM) and stores instructions and data utilized by the mainframe 100. The DASD 106 is preferably a magnetic storage device such as a hard disk drive and holds instructions and data that can be loaded into the storage 104 and utilized by the CPUs 102. The networking facility 108 preferably provides high-bandwidth connections among the CPUs 102, storage 104, and DASD 106 and also provides connectivity to external networks. In one embodiment, the mainframe 100 is a zSeries mainframe, such as the z900 model, available from IBM Corp., although other types of mainframes can also be utilized.

The operation and resources of the mainframe 100 are logically divided into one or more logical partitions (LPARs) 110. FIG. 1 illustrates four LPARs, labeled 110A-D. Each LPAR 110 is a logical computer system having its own logical CPUs, networking, storage, and DASD. While these logical entities appear to be exclusively dedicated to the LPAR, they are in fact formed of the shared real resources in the mainframe 100.

Each LPAR 110 executes an operating system and different LPARs can execute different operating systems. In one embodiment, at least one LPAR 110 (such as LPAR 110A) executes the VM (Virtual Machine) operating system 111 available from IBM Corp., specifically z/VM version 4.x. The VM operating system 111 is specially designed to host other operating systems in “virtual machines” 112 created by VM. Examples of operating systems that can run in the virtual machines created by VM 111 include Linux, MVS, TPF, and/or another instance of VM. Each virtual machine 112 appears as a separate, dedicated computer system to the operating system running in the virtual machine. In fact, a virtual machine 112 is sharing the resources of its associated LPAR 110, much like how the LPARs are sharing the resources of the mainframe 100. FIG. 1 illustrates that the LPARs 110 are executing VM 111 to provide a set of virtual machine instances 112.

The present invention allows easy installation, optimization, and maintenance of virtual machines instances and the operating systems, applications, and/or other software that execute in the virtual machines. In one embodiment, the operating systems executing on the virtual machines are variants of Linux. However, the present invention can also be used with operating systems other than Linux. Accordingly, the present invention allows an enterprise to efficiently provide distributed computing functionality on a mainframe computer.

As used herein, the “administrator” is a person and/or agent responsible for installing, configuring, and maintaining the virtual machines, operating systems, and/or applications. The “users” are the people and/or agents who utilize the virtual machines to perform tasks. The same people and/or agents can act as both administrators and users.

To utilize the functionality of the present invention, in one embodiment the administrator uses VM or another operating system executing on the mainframe 100 to create four “manager” instances of virtual machines 112A-D. The administrator in turn uses these machines to create, optimize, and maintain instances of “managed” virtual machines. The users, in turn, utilize the managed instances to execute application programs and/or perform other tasks.

In creating the manager instances 112A-D, the administrator preferably establishes four VM identifications (“IDs”). The administrator also allocates CPU cycles, storage 104, and DASD 106 to the virtual machines 112A-D having the VM IDs. The administrator also preferably utilizes the networking facility 108 to create logical (virtual) network connections between the server virtual machines 112A-D. In one embodiment, the network connections support Internet protocol (IP)-based communications for the manager instances 112A-D.

The administrator preferably loads modules into each of the four manager instances 112A-D. As used herein, the term “module” refers to computer program logic and/or any hardware or circuitry utilized to provide the functionality attributed to the module. Thus, a module can be implemented in hardware, firmware, and/or software. In one embodiment, the modules loaded by the administrator cause the four manager instances 112A-D to execute a version of the Linux operating system and software packages (e.g., application programs) for providing the special-purpose functionality described herein.

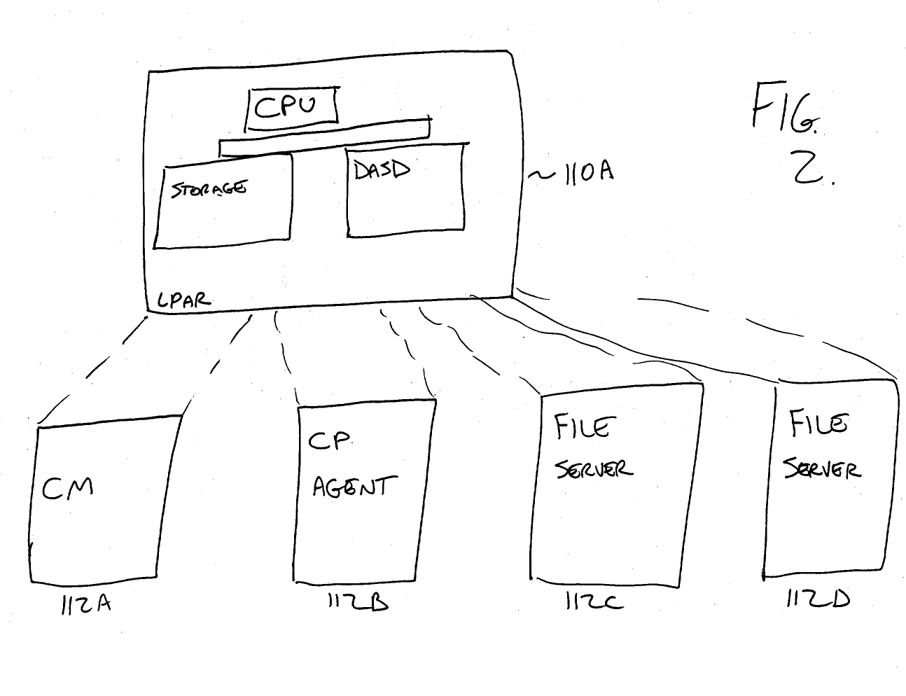

FIG. 2 is a high-level block diagram illustrating a more detailed view of an LPAR 110A and the four manager instances 112A-D. One of the manager instances is the configuration manager (CM) 112A. The CM 112A provides functionality allowing the administrator to create, configure, maintain and delete managed instances. Another of the manager instances is the control program (CP) agent 112B. The CP agent 112B interfaces with a CP executing on the mainframe 100. The CP provides functionality for managing resources on the mainframe 100. Accordingly, the CP agent 112B is utilized by the administrator and/or modules executing in other instances to perform administrative functions on the mainframe 100.

The other manager instances preferably each execute file servers 112C, 112D. The file servers 112C, 112D provide the other instances with access to files stored in the DASD 106. In one embodiment, the two file servers 112C, 112D operate in a redundant manner in order to provide fault-tolerant operation. In another embodiment, there is only one file server instance. This description sometimes refers to the file server instances as the “file server.”

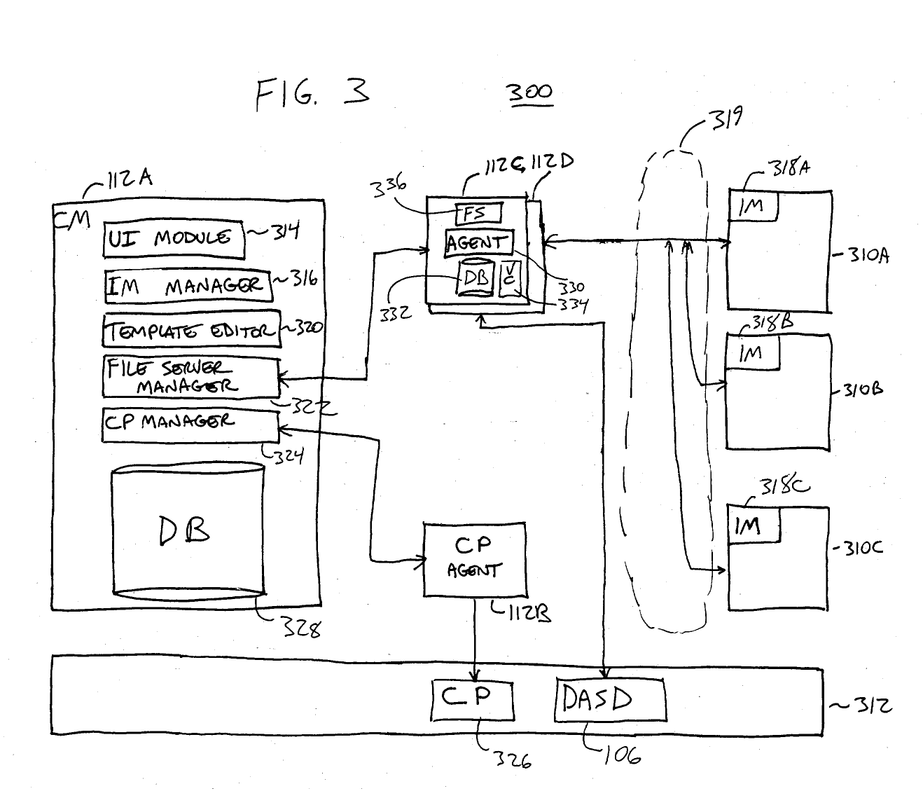

FIG. 3 is a high-level block diagram illustrating an operational view of a system 300 according to the present invention. FIG. 3 illustrates a more detailed view of the manager instances 112A-D, three managed instances 310A-C, and an entity 312 representing resources of the mainframe 100. FIG. 3 also illustrates arrows indicating some of the virtual network connections in the system 300.

Each managed instance 310 preferably executes a module called the “instance manager” (IM) 318. This module 318 facilitates communications between modules in the managed instance 310 and the manager instances 112A-D via a virtual network 319. In one embodiment, the IM module 318 runs continuously in the background and handles periodic service requests. The managed instances 310 are also preferably adapted to access the file server 112C, 112D using the network file system (NFS) protocol over the virtual network 319.

In one embodiment, the virtual network 319 supporting communications among the manager and managed instances is implemented via the Guest LAN functionality provided by the VM operating system 111. The Guest LAN functionality provides extremely fast virtualized networking between the instances. Moreover, the Guest LAN functionality transparently supports Internet protocol (IP) communications, which means that applications and protocols designed to communicate via the IP can use the virtual network 319. Another embodiment of the virtual network 319 utilizes the HiperSockets functionality of VM 111 to implement the virtual network instead of, or in addition to, the Guest LAN functionality.

Turning back to the manager instances 112, FIG. 3 illustrates that one embodiment of the CM 112A contains a number of functional modules. Embodiments of the present invention can have different and/or additional functional modules than the ones illustrated herein. In addition, the functionality attributed to the modules may be distributed through the modules and system 300 in a different manner than is described herein.

The CM 112A preferably includes a user interface (UI) module 314. The UI module 314 provides one or more UIs on a display device associated with the mainframe 100 (the display device is not shown in the figures). The administrator uses the UI to access the functionality provided by the system 300. In one embodiment, the UI module 314 provides three different interfaces: a web browsing interface, a Linux command line interface, and a conversational monitor system (CMS) interface. The web browsing interface allows the administrator to use conventional web browsing functionality, such as hypertext markup language (HTML) web pages, to view and control the operation of the system 300. Similarly, the Linux command line interface provides the administrator with a Linux command line for controlling the system 300 and the CMS interface provides the administrator with a CMS command line interface for controlling the system. Other embodiments of the UI module 314 provide other types of interfaces to the administrator.

A IM manager module 316 in the CM 112A allows the administrator to control the IM modules 318 executing in the managed instances 310. The IM manager module 316 interfaces with the IM modules 318 to send and receive messages and data to and from the modules executing in the managed instances 310. In one embodiment, the IM manager 316 and IM 318 communicate via IP-based protocols over the virtual network connections.

The CM 112A also preferably includes a template editor module 320. Templates describe aspects of the managed instances, such as operating system configurations, installed packages, etc. The administrator utilizes the template editor module 320 to create, modify, and delete templates for managed instances 310. In one embodiment, the template editor module 320 provides functionality allowing an administrator to load a base template, modify it, and save it as a new template. In one embodiment, the template editor module 320 provides functionality allowing an administrator to take a “snapshot” of an existing managed instance 310 and then make a template having the characteristics of the instance. This latter embodiment is useful because it allows an administrator to make configuration changes to a managed instance 310 and then memorialize the changes as a template.

A file server manager module 322 in the CM 112A preferably manages the file server functionality provided by the file server manager instances 112C, 112D. In one embodiment, the file server manager module 322 communicates with the file server 112C, 112D to implement configuration changes and other administrative actions performed by the administrator via the UI module 314. Similarly, a CP manager module 324 in the CM 112A preferably manages the functionality provided by the CP agent virtual machine 112B. The CP manager module 323 thus allows the administrator to communicate with the CP 326 executing on the real machine 312.

The CM 112A also preferably includes a database module 328 storing data utilized by the other modules in the CM. In one embodiment, the database module 328 is implemented using an SQL database such as PostgreSQL or MySQL. The database itself is preferably stored in the DASD space allocated to the CM manager instance 112A.

The file server manager instances 112C, 112D preferably operate under control of the file server manager module 322 to provide file server functionality to the managed instances 310. In one embodiment, the file server manager instances 112C, 112D each include an agent module 330 interfacing with the CM 112A and the managed instances 310. The agent module 330 acts as a file server for the managed instances 310 and makes files in the DASD space allocated to the file server manager instances 112C, 112D appear to be on an NFS shared volume.

The file server manager instances 112C, 112D also each include a file database 332 that holds data managing relationships between the managed instances 310 and the files in the DASD 106. In one embodiment the file database 332 stores data implementing a table describing file mappings for the managed instances 310. The file mappings can selectively map a managed instance's request to access a file, directory, and/or volume to a different file, directory, and/or volume in the DASD 106. For example, the table can implement the following relationships:

| Managed Instance | File | Remap |
|---|---|---|
| 1 | /lib/libc.so.6 | /mmt/glibc-14/lib/libc.so.6 |
| 2 | /lib/libc.so.6 | /mmt/glibc-14/lib/libc.so.6 |
| 3 | /lib/libc.so.6 | /mmt/glibc-15/lib/libc.so.6 |

This table indicates that the file server 112C, 112D remaps requests by managed instances 1 and 2 for “/lib/libc.so.6” to the directory containing version 14 of the requested file. In contrast, the file server 112C, 112D remaps requests by managed instances 3 for “/lib/libc.so.6” to a directory containing version 15 of the requested file. Thus, the file database 332 allows the file server manager instances 112C, 112D to provide different managed instances 310 with different files, even when the managed instances “think” they are accessing the same files. Such remapping effectively allows different managed instances to execute different versions of software packages and/or data files even though the configurations of the managed instances are otherwise identical.

In one embodiment, the file server manager instances 112C, 112D also include a version control module 334 that logs and tracks changes to files utilized by the managed instances 310. In one embodiment, the version control module 334 is implemented with the Concurrent Versions System (CVS) package which is an open source revision control system. Changes to a manager instance and/or a managed instance are encapsulated into “transactions” that are saved in the database 328. For example, transactions can include the following: changes to a managed instance's installed package list; changes related to users of the managed instances; changes to an instance's virtual machine configuration; and changes to an instance's configuration files. In one embodiment, the latter type of transactions, changes to an instance's configuration files, are selectively logged and tracked by the version control module 334. In another embodiments, one or more of the other types of transactions are also logged.

To implement version control for a file according to one embodiment, the administrator uses the IM manager 316 to communicate with the IM 318 of the managed instance 310 and cause the instance to execute functionality logging the configuration file or files into the version control module 334. When the logged files are modified, the version control module 334 maintains a history of the files and tracks the modifications. In this manner, the administrator can easily view and roll back changes to the tracked files. Moreover, the administrator can exploit the version control data to make identical changes to the configuration files of other managed instances 310, thereby allowing changes to be rolled out and/or rolled back with ease.

The file server manager instances 112C, 112D also preferably include a failsafe module 336 for detecting whether a failure condition exists in the other file server manager instance. In one embodiment, the two file server manager instances 112C, 112D act in a master/slave relationship where the slave machine will become the master if it detects an error in the master.

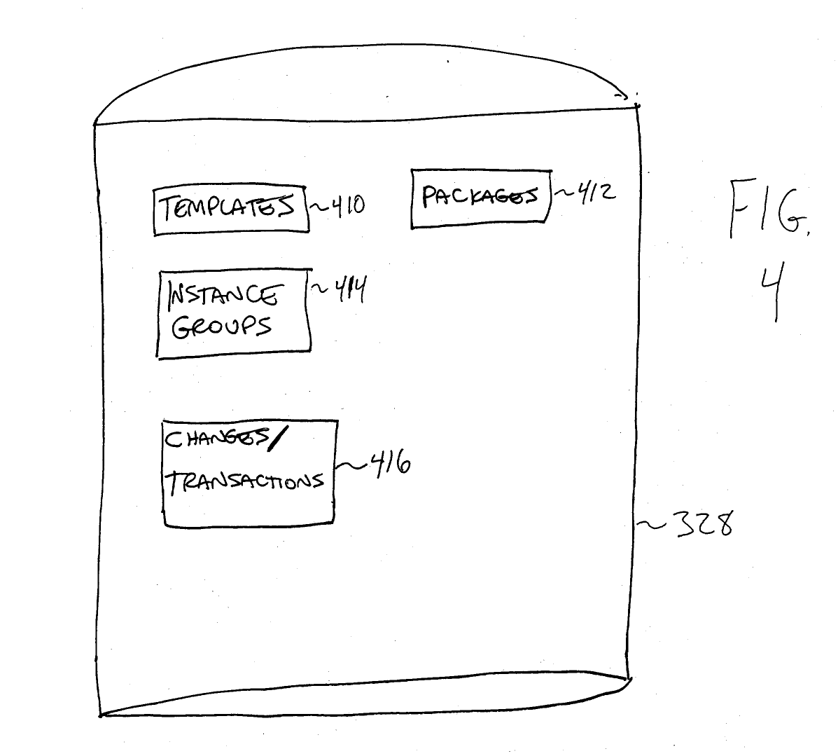

FIG. 4 is a high-level block diagram illustrating a more detailed view of the database 328 in the CM 112A virtual machine of FIG. 3. FIG. 4 illustrates modules representing logical groupings of data within the database 328. It should be understood that the actual organization of data within the database 328 depends upon the particular embodiment. Moreover, embodiments of the database 328 may have different and/or additional data than the data described herein.

The database 328 includes a templates module 410 that stores the templates. In one embodiment, a template is a data structure describing aspects of the managed instance, including the mainframe resources available to the instance and the software configuration within the instance. The data in the template describing mainframe resources specify parameters such as the amount of storage 104 and DASD 106 available to the managed instance, the CPU priority for the instance, networking connections for the instance, etc.

The data in the template describing the software configuration for the managed instance specify the configuration of the operating system for the instance. In one embodiment, the default operating system is Linux and the template describes the initial settings for the operating system by specifying the configuration files in the DASD 106 that are utilized by the operating system. In addition, the software configuration data can specify any software packages that are available to the instance and the initial configurations of those packages. Such packages might include, for example, a web server such as Apache. In one embodiment, the data in the template specify file mappings that the file server 112C, 112D can perform in order to implement the software configuration in the managed instance. In another embodiment, the data identify the software configuration, but other modules determine the file server mappings.

A template also preferably includes meta-data describing the template itself. These data include, for example, the name of the template, the name of the Linux distribution installed in the managed instance 310 by the template, and information for configuring the system 300 to create the managed instance specified by the template.

In one embodiment, the templates module 410 in the database 328 stores templates for frequently used managed instances. For example, in one embodiment the module 410 holds a “high-performance web server” template that creates a managed instance 310 having appropriate mainframe resources, network connections, installed packages, and operating system files to optimize the instance's use as a web server. Similarly, other templates create managed instances optimized to execute certain applications and/or serve as file transfer protocol (FTP) servers, mail servers, software development machines, software testing machines, etc.

A packages module 412 in the database 328 stores data describing the Linux distributions (and/or other operating systems) and software packages (e.g., application programs) available to the managed instances 310. In one embodiment, this module 412 stores data describing the distributions and packages that have been loaded into the DASD 106 and the files comprising each distribution and/or package. The data in the packages module 412 are utilized by the templates and other modules in the system 300 to make particular distributions and/or packages available to the managed instances 310. For example, if a template specifies that the Apache web server package is available to a managed instance, the CM 112A can use the data in the packages module 412 to identify the files in the DASD 106 comprising the package and configure the file server 112C, 112D to allow the managed instance to read those files.

An instance groups module 414 holds data describing relationships among the managed instances and/or the users. The administrator can define groups and place sets of the managed instances 310 in the groups. In addition, the administrator can create one or more “roles” and assign each role specific rights with respect to one or more of the instance groups. The administrator can assign the users to one or more of the roles. Each user takes on the specific rights of all of the roles to which the user is assigned. The data in the instance groups module 414 describe the relationships and other information about the instance groups, roles, and users.

In one embodiment, the administrator uses the data in the instance groups module 414 to make changes that affect groups of managed instances 310 and/or users. For example, the administrator can give more CPU time to an instance group of public web servers during periods of peak usage. Thus, the instance groups module 414 allows the administrator to effectively and easily control a large number of managed instances 310 that may be running at any given time on the mainframe 100.

A changes/transactions module 416 holds data utilized by the version control modules 334 in the file servers 112C, 112D. Accordingly, the changes/transaction module 416 data describe histories of files accessed by the managed instances 310.

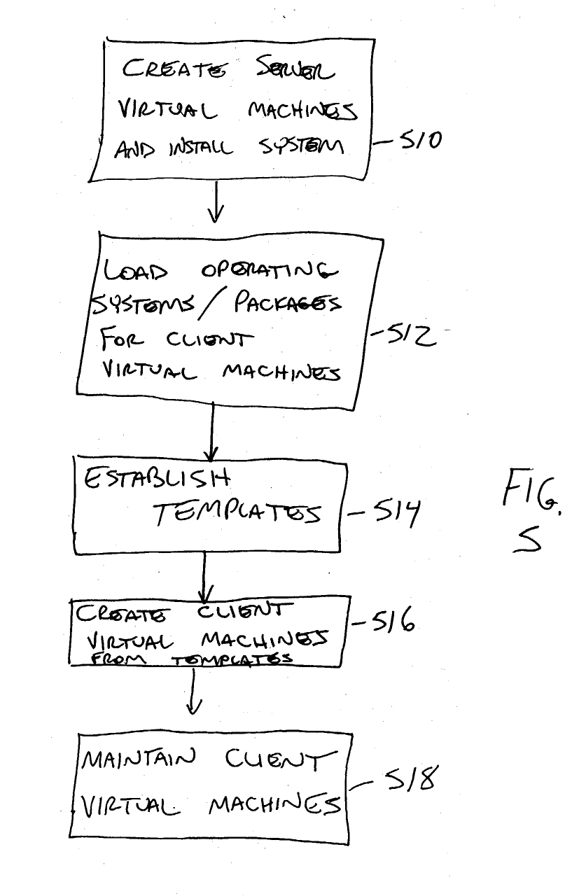

FIG. 5 is a flow chart illustrating steps for utilizing the system of FIG. 3 to manage multiple managed instances according to one embodiment of the present invention. It should be understood that these steps are illustrative only, and that other embodiments of the present invention may perform different and/or additional steps than those described herein in order to perform different and/or additional tasks. Furthermore, the steps can be performed in different orders and/or performed by different entities than described herein.

Initially, the administrator configures the mainframe computer system 100 to create 510 the manager instances 112A-D. In one embodiment, the administrator manually configures the mainframe 100 to create four virtual machines 112 and in another embodiment the administrator executes a software module on the mainframe that automatically creates the machines. In one embodiment, the administrator then executes an installation program that loads program modules for providing the functionality of the manager instances 112A-D into the DASD 106. The installation program executes the program modules in the DASD 106 in the appropriate virtual machines 112A-D to activate the manager instances and cause the mainframe 100 to operate the system 300 of FIG. 3.

At this point, the administrator preferably uses the UIs provided by the UI module 314 to access the functionality of the system 300. The administrator uses the functionality to load 512 operating systems for the managed instances 310, such as one or more distributions of Linux, into the DASD 106. The system 300 preferably stores data in the packages module 412 describing the operating systems and the files in the DASD 106 that comprise each operating system. The administrator also preferably loads one or more software packages into the DASD 106 and stores data describing each package's files in the packages module 412. Preferably, only one copy of each operating system and/or package is installed in the DASD 106. However, there may be multiple different versions of configuration files for use by the various different managed instances 310.

Typically, Linux packages are distributed in a compressed state. Accordingly, an embodiment of the present invention uses “lazy unpacking.” The packages are initially stored in the compressed state, but are decompressed (i.e., expanded) into the normal executable state when the packages are first added to an instance. The decompressed software is stored on the DASD 106 for subsequent use. As a result, the files forming the packages that are utilized by at least one instance are stored in the DASD 106 in an immediately-executable state.

The administrator preferably establishes 514 one or more managed instance templates. In one embodiment, the installation program automatically installs templates in the templates module 410 for creating managed instances optimized for performing certain tasks. The administrator can also establish 514 the templates by utilizing the template editor 320 to create one or more templates and store them in the templates module 410.

The administrator uses the UI provided by the UI module 314 to instruct the system 300 to create 516 a corresponding managed instance 310. In response, the system 300 uses the functionality of the CP agent 112B to create the managed instance having the properties specified by the template. The system 300 also accesses the information in the packages module 412 to identify the files in the DASD 106 corresponding to the operating system and software packages for the managed instance 310 and creates entries in the file database 332 establishing the mappings and permissions for those files. These mappings cause the managed instance 310 to use the operating system, configuration files, software packages, etc. specified by the template.

In a typical embodiment, the administrator uses the templates and system 300 to create 516 many managed instances 310 for serving the needs of the enterprise. As discussed above, the administrator uses instance groups and roles to establish user rights with respect to the various managed instances 310. The users use the appropriate managed instances 310 to perform various tasks.

An advantage to using templates in this manner is that consistent virtual machine environments can be utilized for managed instances across the mainframe 100 and enterprise. For example, a developer can optimize a managed instance and its operating system for executing a particular application and then generate a corresponding template. Software testers can use the template to create identical managed instances in which to test the application. Finally, the application and its corresponding template can be rolled out for general use. Thus, the template allows the users to always execute the application in an optimized state.

Another advantage of using templates in this manner is that the administrator can create identical copies of managed instances 310. For example, assume that a managed instance 310 created with a template executes a server for serving web pages to the public. When traffic grows and threatens to overload the web server, the administrator can meet the growth by using the template to create additional identical managed instances executing web servers. Thus, the administrator can use templates to create an easily-scalable web server.

The administrator also uses the system 300 to maintain 518 the managed instances 310. In this description, “maintenance” refers to changing the operation or functionality of a managed instance by making changes such as patching a vulnerability in the operating system, upgrading or installing (“rolling out”) a software package, or reversing (“rolling back”) previous maintenance.

The file server functionality provided by the file server manager instances 112C, 112D simplifies maintenance in the system 300. Since the files are all preferably stored in one place—the DASD 106—and file access control is preferably centralized in one place—the file database 332—it is quick and easy for the administrator to make changes to the files and/or instances. This unified storage minimizes storage requirements on the DASD 106 and allows for easy backups of the file system. In one embodiment, the administrator executes a backup agent in the CM 112A to backup the files in the DASD 106.

Moreover, the unified storage allows the administrator to efficiently roll out changes or other maintenance. For example, the administrator can make a software package available to a set of the managed instances 310 by loading the package into the DASD 106 (as discussed at step 512) and updating the table in the file database 332 to grant the managed instances access to the files comprising the package. In a similar fashion, the administrator can introduce a new version of an existing software package by installing the new version in the DASD 106 and making it available to a particular managed instance. The administrator can test the new version of the software package to ensure that it works correctly and does not create any conflicts with other software installed in the managed instance. If the new version of the package works correctly, the administrator can update the mappings in the file database 332 to automatically and transparently cause the other managed instances 310 to use the new version instead of the old one. The administrator can also make more granular changes by, for example, creating a new configuration file in the DASD 106 and then modifying the file database table to cause a set of managed instances 310 to use that file.

The administrator can also efficiently roll back changes or other maintenance. The administrator can uninstall a software package from a set of managed instances 310 by updating the table in the file database 332 to deny the machines access to the files comprising the package. Likewise, the administrator can update the table to cause a set of managed instances 310 to revert to an earlier version of an installed package or configuration file.

In sum, the present invention allows efficient operation of managed instances 310 on a mainframe computer system 100. Templates specify parameters of the managed instances 310 and the software executing in the machines. In addition, a file server 112C, 112D provides the managed instances 310 with access to files in the DASD 106 and controllably sets file permissions and mappings. This functionality allows an administrator to conveniently manage multiple instances of virtual machines.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

We claim:

1. A system for managing instances of virtual machines on a computer system, the system comprising:
a file server module adapted to receive file access requests from managed instances executing on the computer system and selectively map the file access requests to files stored in a storage device associated with the computer system;
a template describing aspects of a managed instance for execution on the computer system and software available to the instance; and
a configuration manager module adapted to create a managed instance on the computer system having the aspects described by the template and to establish mappings in the file server module making the software described by the template available to the managed instance.

2. The system of claim 1, wherein the configuration manager module and the file server module respectively execute in separate virtual machine instances on the computer system.

3. The system of claim 1, wherein the template describes aspects and software for a managed instance optimized for a specific purpose.

4. The system of claim 1, wherein the template further describes file mappings for the managed instance and wherein the configuration manager module is further adapted to establish the mappings described by the template in the file server module.

5. The system of claim 1, further comprising:
a database holding data utilized by the configuration manager module to create the managed instance on the computer system.

6. The system of claim 5, wherein the database comprises:
a templates module holding a plurality of templates describing aspects of a plurality of managed instances, wherein the configuration manager module is adapted to create managed instances having the aspects described by the templates.

7. The system of claim 5, wherein the database comprises:
a packages module holding data describing files forming software packages stored in the storage device associated with the computer system.

8. The system of claim 7, wherein the configuration manager is adapted to use the data in the packages module to establish mappings in the file server module making the software specified by the template available to the managed instance.

9. The system of claim 8, wherein the software is an operating system.

10. The system of claim 5, wherein the database comprises:
an instance groups module holding data describing relationships among sets of managed instances executing on the computer system and sets of users of the managed instances.

11. The system of claim 10, wherein the data in the instance groups module restricts access to particular set of managed instances to only a particular class of users.

12. The system of claim 1, wherein the computer system includes a control program for accessing resources of the computer system, further comprising:
a control program manager module for providing an interface between the configuration manager module and the control program, wherein the configuration manager module accesses the control program -to create the managed instance on the computer system.

13. The system of claim 1, wherein the storage device is a direct access storage device (DASD) and wherein the file server makes the DASD appear to the managed instance as at least one network file system volume.

14. The system of claim 1, wherein the file server module comprises:
a file database holding data managing relationships between the managed instances and the files in the storage device.

15. The system of claim 14, wherein the data managing relationships comprise:
data for selectively mapping file requests from a first managed instance for a identified file to a first file in the storage device and for selectively mapping file requests from a second managed instance for the identified file to a second file in the storage device.

16. The system of claim 1, further comprising:
a version control module adapted to track changes to files utilized by the managed instance.

17. A method for managing virtual machines on a mainframe computer, comprising:
loading software into a storage device associated with the mainframe computer, the software comprising a plurality of files;
establishing one or more managed instance templates, a template describing aspects of a managed instance and software available to the managed instance;
creating a managed instance on the mainframe computer, the managed instance having the aspects described by the template; and
establishing mappings for the managed instance to selected files in the storage device to provide the managed instance with the software described by the template.

18. The method of claim 17, wherein the loading comprises:
loading a plurality of software packages into the storage device; and
storing data representative of the files comprising each software package in a packages module in the storage device, wherein establishing the mappings uses the data representative of the files to provide the managed instance with the software.

19. The method of claim 17, further comprising:
creating a plurality of manager instances on the mainframe computer, the manager instances providing functionality for creating the managed instance and establishing the mappings to selected files for the managed instance.

20. The method of claim 17, further comprising:
editing a managed instance template to create a template describing a managed instance having aspects and available software optimized for performing a specific purpose.

21. The method of claim 17, wherein establishing mappings comprises:
establishing data describing mappings for a plurality of managed instances, the mappings associating files identified by ones of the managed instances with files in the storage device.

22. The method of claim 21, wherein an identified file is mapped to a first file in the storage device for a first managed instance and to a second file in the storage device for a second managed instance.

23. The method of claim 17, further comprising:
establishing rights for classes of users of the managed instance.

24. A computer program product comprising:
a computer-readable medium having computer program logic embodied therein for managing instances of virtual machines on a computer system, the computer program logic comprising:
a file server module adapted to receive file access requests from managed instances of virtual machines executing on the computer system and selectively map the file access requests to files stored in a storage device associated with the computer system;
a template describing aspects of a managed instance for execution on the computer system and software available to the managed instance; and
a configuration manager module adapted to create a managed instance on the computer system having the aspects described by the template and to establish mappings in the file server module making the software described by the template available to the managed instance.

25. The computer program product of claim 24, wherein the configuration manager module and the file server module respectively execute in separate instances of virtual machines on the computer system.

26. The computer program product of claim 24, wherein the template describes aspects and software for a managed instance optimized for a specific purpose.

27. The computer program product of claim 24, wherein the template further describes file mappings for the managed instance and wherein the configuration manager module is further adapted to establish the mappings described by the template in the file server module.

28. The computer program product of claim 24, further comprising:
a database holding data utilized by the configuration manager module to create the managed instance on the computer system.

29. The computer program product of claim 28, wherein the database comprises:
a templates module holding a plurality of templates describing aspects of a plurality of managed instances, wherein the configuration manager module is adapted to create managed instances having the aspects described by the templates.

30. The computer program product of claim 28, wherein the database comprises:
a packages module holding data describing files forming software packages stored in the storage device associated with the computer system.

31. The computer program product of claim 30, wherein the configuration manager is adapted to use the data in the packages module to establish mappings in the file server module making the software specified by the template available to the managed instance.

32. The computer program product of claim 28, wherein the database comprises:
an instance groups module holding data describing relationships among sets of managed instances executing on the computer system and sets of users of the managed instances.

33. The computer program product of claim 32, wherein the data in the instance groups module restrict access to aspects of particular sets of managed instances to only a particular class of users.

34. The computer program product of claim 24, wherein the computer system includes a control program for accessing resources of the computer system, further comprising:
a control program manager module for providing an interface between the configuration manager module and the control program, wherein the configuration manager module accesses the control program to create the managed instance on the computer system.

35. The computer program product of claim 24, wherein the file server module comprises:
a file database holding data managing relationships between the managed instances and the files in the storage device.

36. The computer program product of claim 35, wherein the data managing relationships comprise:
data for selectively mapping file requests from a first managed instance for a identified file to a first file in the storage device and for selectively mapping file requests from a second managed instance for the identified file to a second file in the storage device.

37. The computer program product of claim 24, the computer program logic further comprising:
a version control module adapted to track changes to files utilized by the managed instances.
